(19) United States
(12) Patent Application Publication
(10) Pub. No.: US 2008/0137240 A1
(43) Pub. Date: Jun. 12, 2008

(54) System and method for monitoring speed signals from multiple fans

(75) Inventors: Xiang Yu, Shanghai (CN); Yang Tian, Shanghai (CN)

Correspondence Address: BACON & THOMAS, PLLC, 625 SLATERS LANE, FOURTH FLOOR, ALEXANDRIA, VA, 22314, US

(73) Assignee: TYAN COMPUTER CORP., Taipei (TW)

(21) Appl. No.: 11/785,451

(22) Filed: Apr. 18, 2007

(30) Foreign Application Priority Data
Dec. 8, 2006 (TW) 095146178

(51) Int. Cl. H02H 5/04

(52) U.S. Cl. 361/23; 318/463

(57) ABSTRACT

A system and method is provided for monitoring the speed signals of a first fan and a second fan. The system includes a selection signal generation device, a logic gate, a counter and a control device. The selection signal generation device outputs a selection signal to the logic gate having two different states. Based upon the speed signals and the state of the selection signal, the logic gate outputs an output speed signal representing the speed signal of the first fan or second fan to the counter. The counter converts the output speed signal to a digital speed datum. The control device calculates the speed of the first fan or the second fan according to the selection signal and the digital speed datum. The changes of state of the selection signal permit the system to obtain the respective speeds of the two fans in different access cycles.

### BACKGROUND OF THE INVENTION

1. Field of the Invention

The present invention relates to a cooling technology for electronic products, and, more particularly, to a system and method for monitoring speed signals from multiple fans.

2. Description of the Related Art

With the rapid pace of improvements in semiconductor technologies, the number of transistors in a single integrated circuit (IC) has increased dramatically, and the execution speeds of integrated circuits have also seen dramatic increases. As a result, it has become increasingly important to improve the cooling capabilities for these integrated circuits.

FIG. 1 is a schematic drawing of a prior art fan control module. The hardware monitor 110 uses TACH pins 1˜4 to receive and process fan speed signals (tachometer signals). However, the number of pins available for the hardware monitor 110 is limited, and when there are more fans, more hardware monitors are required. When the pins for the hardware monitor 110 are insufficient, even the addition of a single fan requires the addition of another hardware monitor 120. As shown in FIG. 1, hardware monitors 110, 120 each have four pairs of fan control pins; the fans 131, 132, 133, 134 are controlled by the hardware monitor 110, and a single fan 135 is controlled by the hardware monitor 120. Therefore, under this configuration, the additional hardware monitor 120 occupies space on the motherboard and has extra fan control pins that are unused.

Therefore, it is desirable to provide a system and method for monitoring the speed signals of multiple fans to mitigate and/or obviate the aforementioned problems.

### SUMMARY OF THE INVENTION

A main objective of the present invention is to provide a system and method for monitoring speed signals from multiple fans to avoid unnecessary hardware control circuitry and thus save on manufacturing costs.

According to an embodiment of the present invention, a system for monitoring speed signals of a first fan and a second fan comprises a selection signal generation device, a logic gate, a counter and a control device. The logic gate receives the speed signal of the first fan and the second fan and the selection signal from the selection signal generator to select the speed signal of the first fan or the speed signal of the second fan and output an output speed signal. The counter is connected to the logic gate, and receives the output speed signal from the logic gate and converts the output speed signal into a digital speed datum. The control device is coupled to the counter and the selection signal generator for receiving the digital speed datum and the selection signal and calculating the speed of the first or the second fan according to the selection signal and the digital speed datum.

According to another embodiment of the present invention, a system for monitoring the speed signals of a first fan and a second fan comprises: reading a selection signal, wherein the selection signal has a first state and a second state; accessing the speed of the first fan or the second fan according to the obtained selection signal; rereading the selection signal at least once; confirming whether the obtained selection signals have the same state; and updating the speed of the first fan or the second fan.

According to another embodiment of the present invention, a method for monitoring the speed signals of a first fan and a second fan comprises: reading a selection signal continuously at least twice, wherein the selection signal has a first state and a second state; confirming whether the obtained selection signals have the same state; accessing the speed of the first fan or the second fan according to the obtained selection signal; and updating the speed of the first fan or the second fan.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a prior art fan control module.

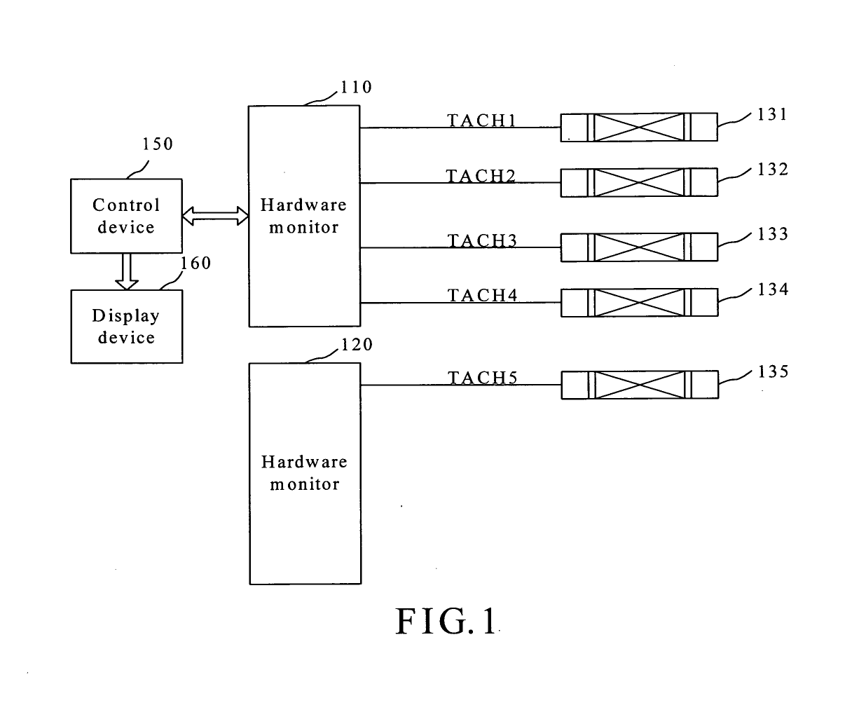

FIG. 2 is functional block drawing of an embodiment of a method for monitoring the speed signals of multiple fans according to the present invention.

FIG. 3 is a timing diagram of a logic gate according to the present invention.

FIG. 4 is flowchart of an embodiment of a method for monitoring speed signals of multiple fans according to the present invention.

### DETAILED DESCRIPTION OF THE PREFERRED EMBODIMENT

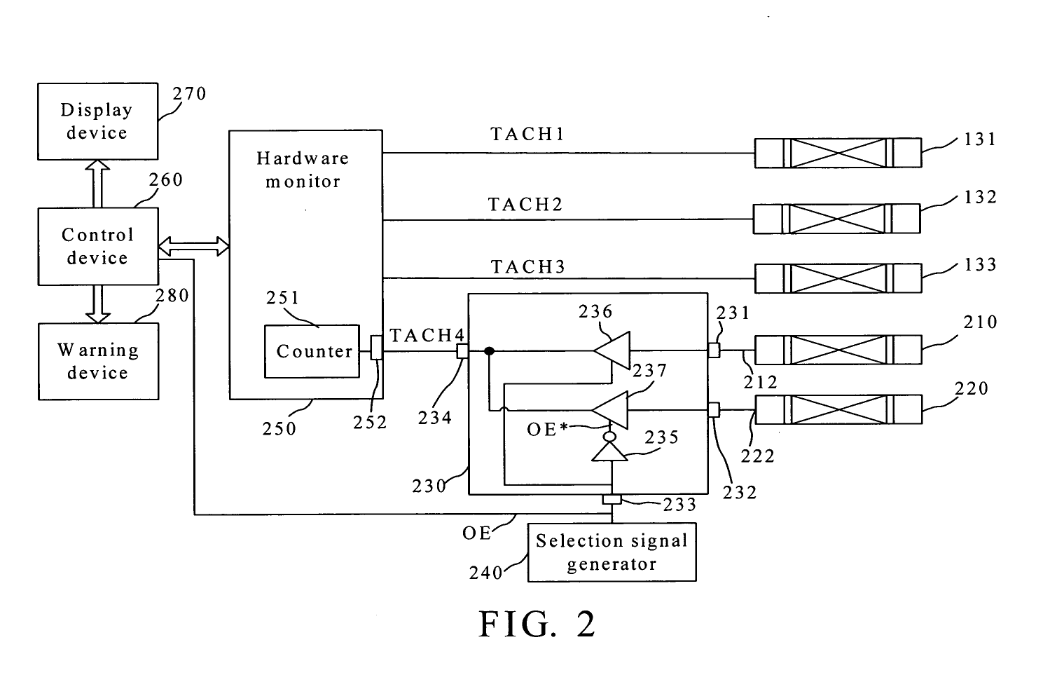

Please refer to FIG. 2. FIG. 2 is functional block drawing of an embodiment of a method for monitoring speed signals of multiple fans according to the present invention. The system comprises a logic gate 230, a selection signal generator 240, a hardware monitor 250, a control device 260, a display device 270 and a warning device 280 and is used for monitoring the speed signals of a first fan 210 and a second fan 220.

The first fan 210 and the second fan 220 respectively have output pins 212, 222. The output pins 212, 222 output a speed signal indicating the rotational speeds of the first fan 210 and the second fan 220.

The selection signal generator 240 is used for generating a selection signal OE. A first input end 231 of the logic gate 230 is connected to the output pin 212 of the first fan 210, a second input end 232 is connected to the output pin 222 of the second fan 220, and a selection input pin 233 is connected to the selection signal generator 240 and used for receiving the selection signal OE to select the speed signal of the first fan 210 or the speed signal of the second fan 220. Then, an output pin 234 of the logic gate 230 outputs an output speed signal.

The selection signal generator 240 may be a square-wave oscillator, which causes the selection signal OE to be a square-wave signal. The selection signal OE has a first state and a second state. The first state is logical high potential, and the second state is logical low potential. Generally, the preferred duty cycle of the selection signal OE is 50%.

The logic gate 230 further comprises an inverter 235, a first switch 236 and a second switch 237. The inverter 235 is connected to the selection signal generator 240 and is used for generating an inverted selection signal OE*.

An enable end of the first switch 236 is connected to the selection signal generator 240 and is used for receiving the selection signal OE. An input end is connected to the first input pin 231 and is used for receiving the speed signal of the first fan 210, and an output end is connected to a monitoring pin 252 of the hardware monitor 250.

An enable end of the second switch 237 is connected to the inverter 235 and is used for receiving the selection signal OE*. An input end is connected to the second input pin 232, and used for receiving the speed signal of the second fan 220. An output end is connected to the monitoring pin 252 of the hardware monitor 250. That is, the output end of the second switch 237 and the output end of the first switch 236 are hard wired together, or are electrically connected.

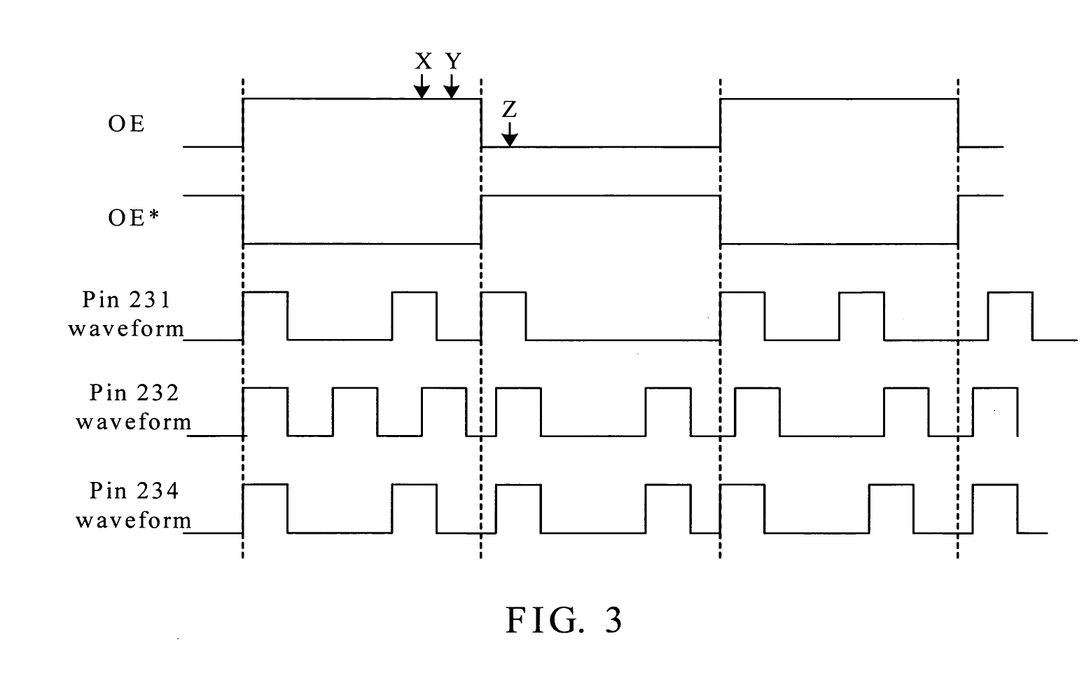

Please refer to FIG. 3. FIG. 3 is a timing diagram of a logic gate according to the present invention. The logic gate 230 selects the speed signal of the first fan 210 or the speed signal of the second fan 220 as output signal of the logic gate 230 according to the selection signal OE. When the selection signal OE is in the first state (a high potential), the logic gate 230 selects the speed signal of the first fan 210 as the output signal. When the selection signal OE is in the second state (a low potential), the logic gate 230 selects the speed signal of the second fan 220 as the output signal.

The monitoring pin 252 of the hardware monitor 250 is connected to the logic gate 230 and is used to receive the output speed signal and convert the output speed signal into a digital speed datum. The hardware monitor 250 further comprises a counter 251.

The counter 251 is connected to the output pin 234 of the logic gate 230 via the monitoring pin 252 and is used for receiving the output speed signal. The counter 251 is triggered to begin counting according to the positive edge of the output speed signal.

The control device 260 is coupled to the hardware monitor 250 and the selection signal generator 240, and is used for receiving the digital speed datum and the selection signal OE and calculating the speed of the first or the second fan according to the selection signal OE and the digital speed datum. The control device 260 reads the value of the counter 251 after every predetermined time period, and then the control device 260 calculates the digital speed datum according to the time period and value of the counter 251. The control device 260 sends the digital speed datum to the display device 270 to display the digital speed datum. The display device 270 may be an LCD, which can display the digital speed datum. The control device 260 may be a south bridge, an SIO controller, an I/O bridge/hub or any other I/O controller.

The warning device 280 is connected to the control device 260; when the speed of the first fan 210 or the second fan 220 is lower than a predetermined value, the control device 260 generates a warning signal and drives the warning device 280 with the warning signal. The warning device 260 may be an LED to generate a visual warning signal. The warning device 260 may also be a speaker or a buzzer to generate an audio warning signal.

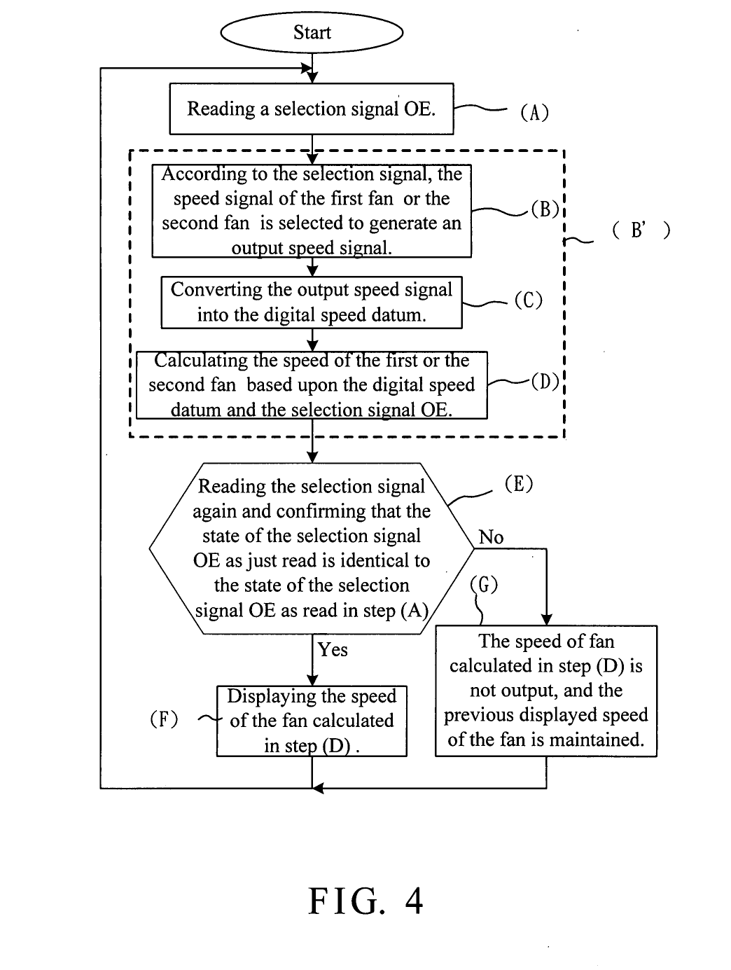

Please refer to FIG. 4. FIG. 4 is flowchart of an embodiment of a method for monitoring the speed signals of multiple fans according to the present invention. The method of the present invention can correctly obtain the speed signal of the first fan 210 and the second fan 220. The method of the present invention substantially comprises executable steps in a section of program code stored in a BIOS (basic input output system), which can be read and executed by a CPU.

First, in step (A), a selection signal OE is read for the first time, in which the selection signal can have a first state or a second state. The first state is a high potential state, and the second state is a low potential state. A 50% duty cycle is preferred for the selection signal OE. The selection signal OE may be sent to a specific pin (not shown) of the control device 260, and the state (voltage level) of this specific pin may be changed by the input selection signal. When the CPU reads the program code related to step (A), the state of this specific pin on the control device 260 may be read to obtain the selection signal.

In step (B), according to the selection signal, the speed signal of the first fan 210 or the second fan 220 is selected to generate an output speed signal. When the selection signal OE is in the first state (the high potential), the speed signal of the first fan 210 is selected to generate an output speed signal. When the selection signal OE is in the second state (the low potential), the speed signal of the second fan 220 is selected to generate an output speed signal. The logic gate 230 selects the speed signal of the first fan 210 or the speed signal of the second fan 220 according to the selection signal OE.

In step (C), the output speed signal is converted into the digital speed datum.

In step (D), based upon the digital speed datum and the selection signal OE, the speed of the first or the second fan is calculated. The control device 260 reads the value of the counter 251 after every predetermined time period, and then the control device 260 calculates the digital speed datum according to the time period and value of the counter 251. With different hardware arrangements, step (C) and/or (D) may both be respectively performed by the hardware monitor 250 or the control device 260. For example, certain types of south bridges may have a built-in counter that can directly receive the speed signal of the fan without any need for the hardware monitor. That is, such types of south bridges integrate some of the functionality of the hardware monitor. Therefore, the present invention may only require the counting capability of the counter, and the hardware monitor may not be necessary. Additionally, the counter may be mounted within the hardware monitor or the control device.

The counter 251 may be directly connected to a GPI (General Purpose Input) pin or a (General Purpose Input/Output) pin of the control device 260. In fact, a pin expander may be coupled between the counter and the control device (not shown), such as a GPI/GPIO expander (general input/general output expander), and this pin expander may have a plurality of GPI/GPIO pins for sending the received signals to the control device 260 intermittently. The pin expander can solve the problem of a lack of pins on the control device 260.

In step (E), the selection signal is read again and it is confirm that the state of the selection signal OE as just read is identical to the state of the selection signal OE as read in step (A). This step may be executed by the CPU. Generally, the processing time of the CPU is significantly less than the variation frequency of the selection signal generator; therefore, two confirmations can provide relatively high accuracy; moreover, two sequential confirmations may also be suitable. Actually, this step may also be divided into two steps of “rereading” and “confirming.”

In step (F), when the state of the selection signal OE is identical to the state of the selection signal OE as read in step (A), the speed of the fan calculated in step (D) is displayed. As shown by the X point and the Y point in FIG. 3, the selection signal OE in step (A) may be in a high potential state (X point), the selection signal OE in step (E) may also be in a high potential state (Y point), and the speed of fan calculated in step (D) is the speed of the first fan. After step (E), the CPU updates the speed of the first or the second fan, and the speed is usually stored in any type of memory or register. However, other processing procedures, such as displaying, warning or other procedures may be added for other purposes.

In step (G), when the state of the selection signal OE is not identical to the state of the selection signal OE as read in step (A), the speed of fan calculated in step (D) is not output, and the previous displayed speed of the fan is maintained. As shown by the Y point and Z point in FIG. 3, the selection signal OE in step (A) may be in a high potential state (Y point), the selection signal OE in step (E) may be in a low potential state (Z point), and the speed of fan calculated in step (D) is the speed of the first or the second fan. The speed of the fan calculated in step (D) is therefore not output, and the previously displayed speed of the fan from the last access cycle is maintained in the current access cycle. After the CPU has confirmed that the selection signals from the two sequential confirmation steps are in different states, the speed of the last access cycle of the first or the second fan is not updated, which means that the displayed result is the same. In the present invention, each access cycle includes reading the selection signal at least twice and confirming whether their states are identical.

In another embodiment, steps (B) to (D) may be merged into a single step (B′): accessing the speed of the first or the second fan according to the selection signal, which is performed by the logic gate, the counter and the control device together. Hence, a core concept of the present invention is to provide a method for monitoring the speed signals of a first fan and a second fan, in which the method comprises: reading a selection signal; accessing the speed of the first or the second fan according to the selection signal; next, rereading the selection signal; confirming whether the two read selection signals are in the same state; and if they are in the same state, updating the speed of the first or the second fan; if the read selection signals are not in the same state, keeping the speed of the first or the second fan from the last access cycle. An extra step is mentioned in the embodiments may be performed: displaying the updated speed of the first or the second fan, which may be optional.

Step (B′) may be executed after step (E). That is, first, the selection signal is read straight two or more times; the selection signals are checked to see if they have the same state; and if they have the same state, the speed of the first or the second fan is accessed according to the selection signal, and the speed of the first or the second fan is updated. If the selection signals do not have the same state, the speed of the first or the second fan of remains the same as in the last access cycle. And the displaying updated speed of the first or the second fan may be an optional step.

From the above description, the present invention utilizes the logic gate 230 to select the speed signal of the first fan 210 or the second fan 220 to reduce the number of pins for the hardware monitor 250. Therefore, the present invention can avoid unnecessary hardware control circuitry to save manufacturing costs.

Although the present invention has been explained in relation to its preferred embodiment, it is to be understood that many other possible modifications and variations can be made without departing from the spirit and scope of the invention as hereinafter claimed.

What is claimed is:

1. A system for monitoring speed signals for a first fan and a second fan, the system comprising:
a selection signal generator for generating a selection signal;
a logic gate for receiving the speed signal of the first fan or the second fan and the selection signal from the selection signal generator to select the speed signal of the first fan or the speed signal of the second fan and to output an output speed signal;
a counter connected to the logic gate for receiving the output speed signal from the logic gate and converting the output speed signal into a digital speed datum; and
a control device coupled to the counter and the selection signal generator for receiving the digital speed datum and the selection signal and calculating the speed of the first fan or the second fan according to the selection signal and the digital speed datum.

2. The system as claimed in claim 1, wherein the logic gate further comprises:
an inverter connected to the selection signal generator for generating an inverted selection signal;
a first switch having an enable end connected the selection signal generator for receiving the selection signal, an input end connected to the first fan for receiving the speed signal of the first fan, and an output end connected to the counter; and
a second switch having an enable end connected t o the inverter for receiving the inverted selection signal, an input end connected to the second fan for receiving the speed signal of the second fan, and an output end hard-wired or in circuit connected to the output end of the first switch.

3. The system as claimed in claim 1, wherein the selection signal generator is a square wave oscillator and is used for generating the selection signal.

4. The system as claimed in claim 1, wherein the selection signal has a 50% duty cycle.

5. The system as claimed in claim 1, wherein the selection signal has a first state and a second state.

6. The system as claimed in claim 5, wherein the first state is a high potential state, and the second state is a low potential state.

7. The system as claimed in claim 5, wherein when the selection signal is in the first state, the logic gate selects the speed signal of the first fan as the output speed signal of the logic gate, and when the selection signal is in the second state, the logic gate selects the speed signal of the second fan as the output speed signal of the logic gate.

8. The system as claimed in claim 1, wherein the counter is installed in a hardware monitor or the control device.

9. The system as claimed in claim 1, wherein the control device is a south bridge, an SIO controller, an I/O bridge/hub or any other I/O controller.

10. The system as claimed in claim 1 further comprising a pin expander coupled between the control device and the counter.

11. A method for monitoring the speed signals of a first fan and a second fan, the method comprising:
reading a selection signal, wherein the selection signal has a first state and a second state;
accessing the speed of the first fan or the second fan according to the obtained selection signal;
re-reading the selection signal at least once;
determining whether the obtained selection signals have the same state; and
updating the speed of the first fan or the second fan.

12. The method as claimed in claim 11, wherein the step of accessing the speed of the first fan or the second fan according to the obtained selection signal further comprises:
selecting the speed signal of the first fan or the speed signal of the second fan to generate an output speed signal according to the selection signal;
converting the output speed signal into a digital speed datum; and
calculating the speed of the first fan or the second fan according to the digital speed datum.

13. The method as claimed in claim 11, wherein the step of accessing the speed of the first fan or the second fan according to the obtained selection signal is performed after the step of determining whether the obtained selection signals have the same state.

14. The method as claimed in claim 11, wherein the step of updating the speed of the first fan or the second fan further comprises displaying the updated speed of the first fan or the second fan.

15. The method as claimed in claim 11, wherein the step of determining whether the obtained selection signals have different states further comprises keeping the speed of the first or the second fan from a previous access cycle.

16. The method as claimed in claim 11, wherein when the selection signal is in the first state, the speed signal of the first fan is selected to generate the output speed signal; and when the selection signal is in the second state, the speed signal of the second fan is selected to generate the output speed signal.

17. The method as claimed in claim 16, wherein the first state is a high potential state, and the second state is a low potential state.

18. A method for monitoring speed signals from a first fan and speed signals from a second fan, the method comprising:
reading a selection signal at least twice consecutively, wherein the selection signal has a first state and a second state;
determining whether the obtained selection signals have the same state;
accessing the speed of the first fan or the second fan according to the obtained selection signal; and
updating the speed of the first fan or the second fan.

19. The method as claimed in claim 18, wherein the step of accessing the speed of the first fan or the second fan according to the obtained selection signal is performed before the step of determining whether the obtained selection signals have the same state.

20. The method as claimed in claim 18, wherein the step of determining whether the obtained selection signals have different states further comprises keeping the speed of the first fan or the second fan from a previous access cycle.
